(19) United States
(12) Patent Application Publication
(10) Pub. No.: US 2008/0085735 A1
(43) Pub. Date: Apr. 10, 2008

(54) METHOD FOR UTILIZING A MOBILE COMMUNICATION DEVICE TO SEARCH AN OBJECT AND RELATED MOBILE COMMUNICATION SYSTEM

(76) Inventor: Hsien-Chung Lin, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/867,010

(22) Filed: Oct. 4, 2007

(30) Foreign Application Priority Data
Oct. 4, 2006 (TW) 095136832

(51) Int. Cl. H04M 1/00

(52) U.S. Cl. 455/556.1

(57) ABSTRACT

A method for utilizing a mobile communication device to search an object includes: (a) attaching a receiver on an object; (b) building wireless connection of the mobile communication device and the receiver; (c) setting object information corresponding to the object in the mobile communication device and generating a first wireless signal according to the object information; (d) the mobile communication device outputting the first wireless signal; (e) the receiver transmitting a second wireless signal to the mobile communication device after receiving the first wireless signal from the mobile communication device; and (f) the mobile communication device displaying information of a location of the object according to the second wireless signal transmitted from the receiver.

### BACKGROUND OF THE INVENTION

1. Field of the Invention

The present invention relates to a method for utilizing a mobile communication device to search an object and a related mobile communication system, and more particularly, to a method for utilizing wireless connection of a mobile communication device and a receiver disposed on an object to search the object and a related mobile communication system.

2. Description of the Prior Art

In highly developed information communication systems in the modern information society, electronic devices are widely utilized in every area. For instance, the utilization of a convenient and lightweight mobile phone device has become a way of communication in our daily life; users can easily exchange and share information, experience, and opinion through the convenience of the mobile phone device. The mobile phone progressed tremendously in recent years and various types of mobile phones are continuously developed. The increasing utilization has created a demand in production, as the mobile phones are becoming common causing the technology of mobile phones to mature with the trend moving towards smaller multi-functional phones. The important issue now is how to design a more convenient mobile phone for the user to utilize.

In daily life, people always take lots of time searching objects, such as searching a remote controller, a key, baggage, even lost children or aged people. The mobile phone is a convenient and powerful personal apparatus with visual display interface and operation interface. It's a pity the current mobile phone is not capable of searching objects for people.

### SUMMARY OF THE INVENTION

It is therefore a primary objective of the claimed invention to provide a method for utilizing a mobile communication device to search an object and a related mobile communication system for solving the above-mentioned problem.

According to the claimed invention, A method for utilizing a mobile communication device to search an object includes: (a) attaching a receiver on an object; (b) building wireless connection of the mobile communication device and the receiver; (c) setting object information corresponding to the object in the mobile communication device and generating a first wireless signal according to the object information; (d) the mobile communication device outputting the first wireless signal; (e) the receiver transmitting a second wireless signal to the mobile communication device after receiving the first wireless signal from the mobile communication device; and (f) the mobile communication device displaying information of a location of the object according to the second wireless signal transmitted from the receiver.

According to the claimed invention, a mobile communication system capable of searching an object is disclosed. The mobile communication device system includes a receiver disposed on the object. The receiver includes a first wireless communication module for transmitting a first wireless signal. The mobile communication device system further includes a mobile communication device including a second wireless communication module for communicating with the first wireless communication module wirelessly, a display module, and a control module electrically connected to the second wireless communication module and the display module for controlling the display module to display information of a location of the object according to the first wireless signal transmitted from the first wireless communication module and received by the second wireless communication module.

According to the claimed invention, a mobile communication device capable of communicating with a receiver disposed on an object is disclosed. The receiver includes a first wireless communication module for transmitting a first wireless signal. The mobile communication device includes a second wireless communication module for communicating with the first wireless communication module, a display module, and a control module electrically coupled to the second wireless communication module and the display module for controlling the display module to display information of a location of the object according to the first wireless signal transmitted from the first wireless communication module and received by the second wireless communication module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a mobile communication system according to a preferred embodiment of the present invention.

FIG. 2 is a functional block diagram of the mobile communication system according to the preferred embodiment of the present invention.

FIG. 3 is a flowchart of utilizing the mobile communication system to search an object according to the preferred embodiment of the present invention.

FIG. 4 is a diagram of a menu showed by a display module for selecting a receiver in a mobile communication device of the present invention.

FIG. 5 is a diagram of a frame showed by the display module for displaying the information of the location of the object of the present invention.

FIG. 6 is a diagram of a frame showed by the display module for displaying the information of low battery of the receiver.

### DETAILED DESCRIPTION

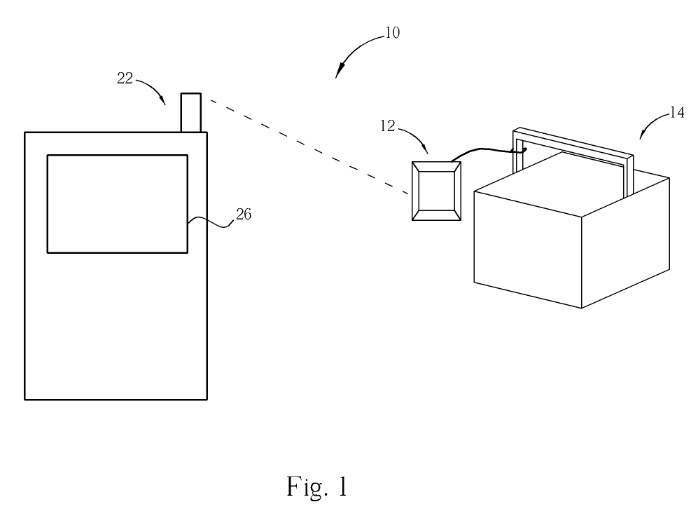

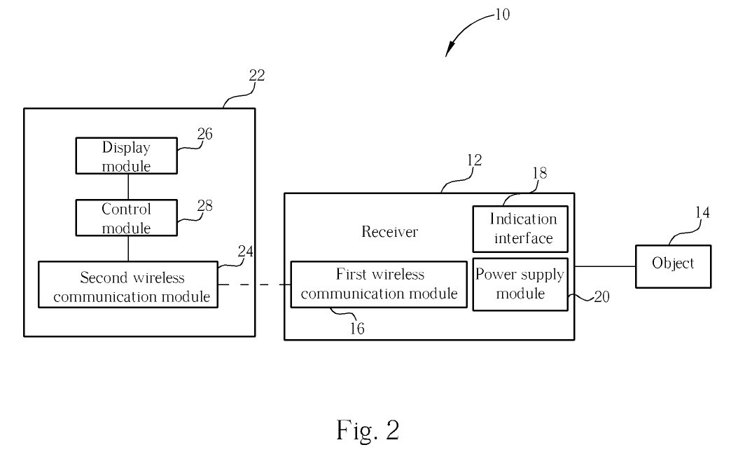

Please refer to FIG. 1 and FIG. 2. FIG. 1 is a schematic drawing of the mobile communication system 10 according to a preferred embodiment of the present invention. FIG. 2 is a functional block diagram of the mobile communication system 10 according to the preferred embodiment of the present invention. The mobile communication system 10 includes at least one receiver 12 for disposing on an object 14. The receiver 12 can be hung on or attached to the object 14, such as a cell phone dangle or a Velcro combined with the object 14. The receiver 12 includes a first wireless communication module 16 for transmitting a wireless signal. The first wireless communication module 16 can be a bluetooth wireless communication module. The receiver 12 further includes an indication interface 18 for presenting an indication information for indicating a location of the object 14. The indication interface 18 can be a speaker for indicating the location of the object 14 by giving off an indication sound. The indication interface 18 can be a light emitter for indicating the location of the object 14 by emitting indication light. The receiver 12 further includes a power supply module 20 for supplying electricity for the receiver 12. The power supply module 20 can be a lithium battery or other types of batteries. The mobile communication system 10 further includes a mobile communication device 22. The mobile communication device 22 includes a second wireless communication module 24 for communicating with the first wireless communication module 16 of the receiver 12 wirelessly. The mobile communication device 22 further includes a display module 26, and a control module 28 electrically connected to the second wireless communication module 24 and the display module 26 for controlling the display module 26 to display information of the location of the object 14 according to the wireless signal transmitted from the first wireless communication module 16 and received by the second wireless communication module 24.

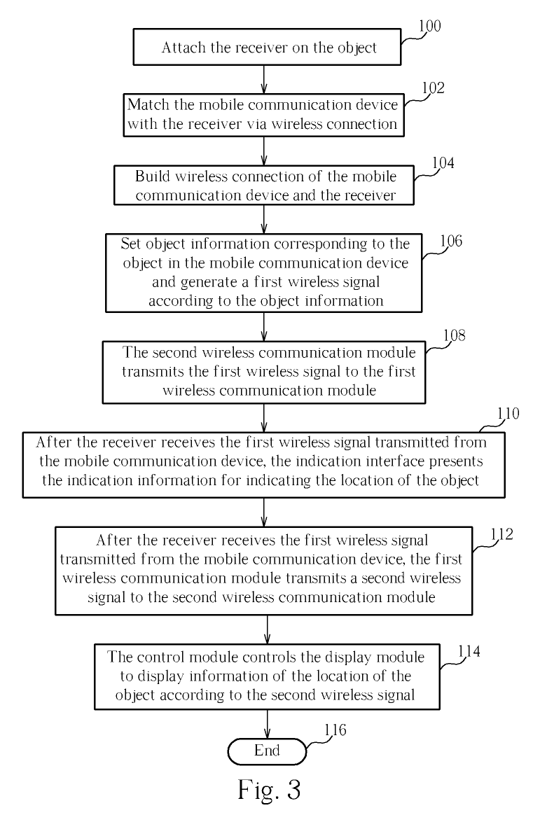

Please refer to FIG. 3. FIG. 3 is a flowchart of utilizing the mobile communication system 10 to search the object 14 according to the preferred embodiment of the present invention. The method includes following steps:

Step 100: Attach the receiver 12 on the object 14.

Step 102: Match the mobile communication device 22 with the receiver 12 via wireless connection.

Step 104: Build wireless connection of the mobile communication device 22 and the receiver 12.

Step 106: Set object information corresponding to the object 14 in the mobile communication device 22 and generate a first wireless signal according to the object information.

Step 108: The second wireless communication module 24 of the mobile communication device 22 transmits the first wireless signal to the first wireless communication module 16 of the receiver 12.

Step 110: After the receiver 12 receives the first wireless signal transmitted from the mobile communication device 22, the indication interface 18 of the receiver 12 presents the indication information for indicating the location of the object 14.

Step 112: After the receiver 12 receives the first wireless signal transmitted from the mobile communication device 22, the first wireless communication module 16 of the receiver 12 transmits a second wireless signal to the second wireless communication module 24 of the mobile communication device 22.

Step 114: The control module 28 of the mobile communication device 22 controls the display module 26 to display information of the location of the object 14 according to the second wireless signal transmitted from the receiver 12.

Step 116: End.

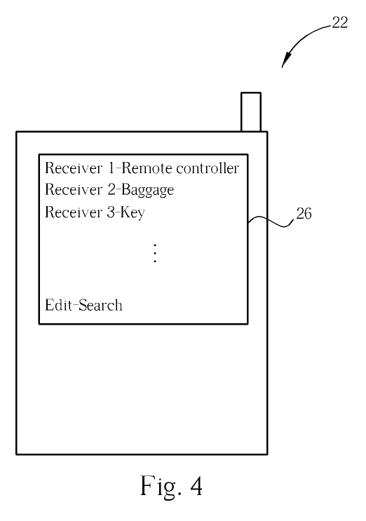

More detailed descriptions for the steps mentioned above will be provided. First a user can attach the receiver 12 on the object 14. Then the mobile communication device 22 and the receiver 12 can be matched via wireless connection. For example, the match mode of the receiver 12 can be activated and the bluetooth function of the mobile communication device 22 can be activated for searching bluetooth peripheral devices nearby if the mobile communication device 22 includes bluetooth wireless communication function and the receiver 12 is a bluetooth peripheral device. The mobile communication device 22 and the receiver 12 can be matched via bluetooth wireless connection after the mobile communication device 22 has searched the receiver 12. After the match of the mobile communication device 22 and the receiver 12 is complete, the match mode of the receiver 12 is terminated and identification of the receiver 12 is stored in the mobile communication device 22 even through rebooting the mobile communication device 22. A master device can match with seven slave devices of the current bluetooth standard. That is, the mobile communication device 22 can match with seven receivers 12 at most and can monitor locations of seven objects 14 simultaneously. Once the mobile communication device 22 succeeds in matching with the receiver 12, the wireless connection of the mobile communication device 22 and the receiver 12 is built. If there is a plurality of the receivers 12 of the mobile communication system 10, the plurality of the receivers 12 can be disposed on a plurality of the objects 14 respectively. Then the mobile communication device 22 and the plurality of the receivers 12 can be matched via wireless connection. The user can set object information corresponding to each object 14 (the receiver 12) in the mobile communication device 22, such as editing names corresponding to the plurality of the receivers 12 (can be named as names of the objects). If the user wants to be aware of the location of the certain object 14 of the plurality of the objects 14, the user can select the receiver 12 corresponding to the certain object 14 in the mobile communication device 22. For example, please refer to FIG. 4. FIG. 4 is a diagram of a menu showed by the display module 26 for selecting the receiver 12 in the mobile communication device 22 of the present invention. The user can select the receiver 12 corresponding to the object 14 which the user wants to know the location with the menu showed by the display module 26.

After the user selects a certain receiver 12, the mobile communication device 22 generates the first wireless signal according to the object information corresponding to the receiver 12. The second wireless communication module 24 transmits the first wireless signal to the first wireless communication module 16 of the selected receiver 12. After the first wireless communication module 16 of the selected receiver 12 receives the first wireless signal, the indication interface 18 of the receiver 12 presents the indication information for indicating the location of the object 14 to the user by sounds or light. Simultaneously, the first wireless communication module 16 of the receiver 12 transmits the second wireless signal to the second wireless communication module 24 of the mobile communication device 22. The control module 28 of the mobile communication device 22 can calculate an estimative distance between the mobile communication device 22 and the object 14 connected with the receiver 12 according to the first wireless signal and the second wireless signal transmitted from the receiver 12. For example, the distance between the mobile communication device 22 and the object 14 can be derived from the following formula:

the distance between the mobile communication device 22 and the object 14=(a time point of the mobile communication device 22 receiving the second wireless signal—a time point of the mobile communication device 22 transmitting the first wireless signal—the processing time of the receiver 12)/2.

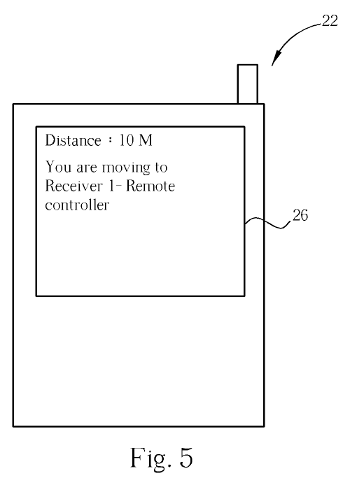

That is, the distance between the mobile communication device 22 and the object 14 can be estimated by the product of the transmission time of the wireless signal and the transmission speed of the wireless signal. Additionally, the control device 28 of the mobile communication device 22 can determine that the mobile communication device 22 moves to the object 14 or moves away from the object 14 according to the second wireless signal transmitted from the receiver 12. For example, the control device 28 of the mobile communication device 22 can determine that the mobile communication device 22 moves to the object 14 or moves away from the object 14 according to enhancement or decay of the signal strength (RSSI value) of the second wireless signal. When the signal strength of the second wireless signal is getting strong, the mobile communication device 22 is moving close to the object 14. On the other hand, when the signal strength of the second wireless signal is getting weak, the mobile communication device 22 is moving far away from the object 14. For example, please refer to FIG. 5. FIG. 5 is a diagram of a frame showed by the display module 26 for displaying the information of the location of the object 14 of the present invention. The control module 28 of the mobile communication device 22 controls the display module 26 to display the calculated distance between the mobile communication device 22 and the object 14 and to display a status that the mobile communication device 22 moves to the object 14 or moves away from the object 14 for a basis of searching the object 14. The above-mentioned steps can be repeated until the user finds the object 14.

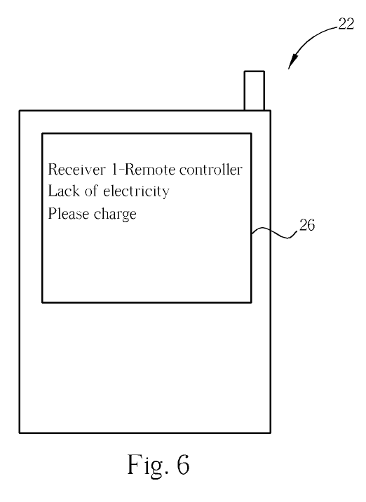

In addition, when the power supply module 20 of the receiver 12 is in a condition of low battery, the receiver 12 can transmit a third wireless signal to the mobile communication device 22 and the control module 28 of the mobile communication device 22 can control the display module 26 to display information of low battery of the receiver 12 according to the third wireless signal for informing the user of replacing or charging the power supply module 20. For example, please refer to FIG. 6. FIG. 6 is a diagram of a frame showed by the display module 26 for displaying the information of low battery of the receiver 12. It can inform the user of replacing or charging the power supply module 20 with low electricity of the receiver 12.

In contrast to the prior art, the present invention utilizes the wireless connection of the mobile communication device and the receiver disposed on the object for searching the object, such as a remote controller, a key, baggage, even lost children or aged people carrying the receiver. It is convenient for the user to search the object via the indication sound or light produced by the receiver and with the information of the distance or relative movement showing on the display module of the mobile communication device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for utilizing a mobile communication device to search an object comprising:
(a) attaching a receiver on an object;
(b) building wireless connection of the mobile communication device and the receiver;
(c) setting object information corresponding to the object in the mobile communication device and generating a first wireless signal according to the object information;
(d) the mobile communication device outputting the first wireless signal;
(e) the receiver transmitting a second wireless signal to the mobile communication device after receiving the first wireless signal from the mobile communication device; and
(f) the mobile communication device displaying information of a location of the object according to the second wireless signal transmitted from the receiver.

2. The method of claim 1 wherein step (b) comprises building bluetooth wireless connection of the mobile communication device and the receiver, and step (c) comprises matching the mobile communication device with the receiver via bluetooth wireless connection.

3. The method of claim 1 further comprising the step that the receiver presenting an indication information for indicating the location of the object after receiving the first wireless signal from the mobile communication device.

4. The method of claim 3 wherein the indication information is selected from the group consisting of a sound and a light.

5. The method of claim 1 wherein step (f) comprises the mobile communication device calculating a distance between the mobile communication device and the object according to the second wireless signal transmitted from the receiver and the mobile communication device displaying the distance between the mobile communication device and the object.

6. The method of claim 1 wherein step (f) comprises the mobile communication device determining that the mobile communication device moves to the object or moves away from the object according to the second wireless signal transmitted from the receiver and the mobile communication device displaying a status that the mobile communication device moves to the object or moves away from the object.

7. The method of claim 6 wherein step (f) further comprises the mobile communication device determining that the mobile communication device moves to the object or moves away from the object according to enhancement or decay of the second wireless signal.

8. The method of claim 1 further comprising the receiver transmitting a third wireless signal to the mobile communication device and the mobile communication device displaying information of low battery of the receiver according to the third wireless signal transmitted from the receiver.

9. A mobile communication system being capable of searching an object, the mobile communication device system comprising:
a receiver disposed on the object, the receiver comprising a first wireless communication module for transmitting a first wireless signal; and
a mobile communication device comprising:
a second wireless communication module for communicating with the first wireless communication module wirelessly;
a display module; and
a control module electrically connected to the second wireless communication module and the display module for controlling the display module to display information of a location of the object according to the first wireless signal transmitted from the first wireless communication module and received by the second wireless communication module.

10. The mobile communication system of claim 9 wherein the first wireless communication module and the second wireless communication module are bluetooth wireless communication modules.

11. The mobile communication system of claim 9 wherein the receiver further comprises an indication interface for presenting indication information for indicating the location of the object after the first wireless communication module receives a second wireless signal transmitted from the second wireless communication module.

12. The mobile communication system of claim 11 wherein the indication interface is selected from the group consisting of a speaker and a light emitter.

13. The mobile communication system of claim 9 wherein the control module controls the display module to display a status that the mobile communication device moves closer to the object or moves away from the object according to enhancement or decay of the strength of the first wireless signal transmitted from the first wireless communication module and received by the second wireless communication module.

14. The mobile communication system of claim 9 wherein the control module controls the display module to display information of low battery of the receiver according to the first wireless signal transmitted from the first wireless communication module and received by the second wireless communication module.

15. A mobile communication device capable of communicating with a receiver disposed on an object, and the receiver comprising a first wireless communication module for transmitting a first wireless signal, the mobile communication device comprising:
a second wireless communication module for communicating with the first wireless communication module;
a display module; and
a control module electrically coupled to the second wireless communication module and the display module, the control module controlling the display module to display information of a location of the object according to the first wireless signal transmitted from the first wireless communication module and received by the second wireless communication module.

16. The mobile communication device of claim 15 wherein the first wireless communication module and the second wireless communication module are bluetooth wireless communication modules.

17. The mobile communication device of claim 15 wherein the receiver further comprises an indication interface for presenting indication information for indicating the location of the object after the first wireless communication module receives a second wireless signal transmitted from the second wireless communication module.

18. The mobile communication device of claim 17 wherein the indication interface is selected from the group consisting of a speaker and a light emitter.

19. The mobile communication device of claim 15 wherein the control module controls the display module to display a status that the mobile communication device moves closer to the object or moves away from the object according to enhancement or decay of the strength of the first wireless signal transmitted from the first wireless communication module and received by the second wireless communication module.

20. The mobile communication device of claim 15 wherein the control module controls the display module to display information of low battery of the receiver according to the first wireless signal transmitted from the first wireless communication module and received by the second wireless communication module.
